(19) United States
(12) Patent Application Publication
(10) Pub. No.: US 2024/0198596 A1
(43) Pub. Date: Jun. 20, 2024

(54) Powder Bed Measurement For Additive Manufacturing

(71) Applicant: Seurat Technologies, Inc., Wilmington, MA (US)

(72) Inventors: Francis L. Leard, Sudbury, MA (US); James A. DeMuth, Woburn, MA (US); Andrew J. Bayramian, Marblehead, MA (US); Yiyu Shen, Tewksbury, MA (US)

(21) Appl. No.: 18/534,246

(22) Filed: Dec. 8, 2023

Related U.S. Application Data
(60) Provisional application No. 63/387,607, filed on Dec. 15, 2022.

(51) Int. Cl. B29C 64/386; B29C 64/153; B29C 64/268; B33Y 30/00; B33Y 50/00

(52) U.S. Cl. CPC B29C 64/386; B29C 64/153; B29C 64/268; B33Y 30/00; B33Y 50/00

(57) ABSTRACT

A print engine of an additive manufacturing system that supports powder measurement systems includes a print bed able to hold powder of varying sizes. A laser energy patterning system is made to be directable against the print bed and a backscatter detection system is situated to evaluate scattered light distribution from powder on the print bed and determine powder size.

### RELATED APPLICATION

The present disclosure is part of a non-provisional patent application claiming the priority benefit of U.S. Patent Application No. 63/387,607, filed on Dec. 15, 2022, which is incorporated by reference in its entirety.

### TECHNICAL FIELD

The present disclosure generally relates to a system and method for powder bed diagnostics in additive manufacturing. In some embodiments, particle size and distribution in the powder bed are provided using various backscattering measurements.

### BACKGROUND

Traditional component machining often relies on removal of material by drilling, cutting, or grinding to form a part. In contrast, additive manufacturing, also referred to as 3D printing, typically involves sequential layer by layer addition of material to build a part. Beginning with a 3D computer model, an additive manufacturing system can be used to create complex parts from a wide variety of materials.

One additive manufacturing technique known Powder Bed Fusion Additive Manufacturing (PBF-AM) uses one or more focused energy sources to draw a pattern in a thin layer of powder by melting the powder and bonding it to the layer below to gradually form a 3D printed part. Powders can be plastic, metal, glass, ceramic, crystal, other meltable material, or a combination of meltable and unmeltable materials (i.e. plastic and wood or metal and ceramic). Packing density of powder prior to fusing in can play an important role in the density of the final printed parts. Pores, voids, and cracks (printing defects) can occur with low packing density or unwanted variability in powder spreading or distribution.

To reduce printing errors, systems and methods are needed to allow for testing and diagnostics of powder characteristics, including particle size and distribution. Ideally, diagnostics for a powder layer prior and during printing would be available to determine quality of the powder size distributions, powder bed layer thickness, and how the powder size distributions are distributed. This information can be used adjust the beam print parameters, as well as predict and determine remelt post processing beam profiles of any printed layer.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates an additive manufacturing system suitable for use in conjunction with described diagnostic systems and methods;

FIG. 2A illustrates one embodiment of a diagnostic and measurement technique that relies on backscatter measurement for powder size determination on a print bed;

FIG. 2B illustrates an example of use of backscatter and controlled coherency system to determine powder size and powder depth;

FIG. 2C illustrates an example of volumetric printing system in additive manufacturing using adaptive optical techniques with backscatter coherence analysis;

FIG. 2D illustrates an example of a diagnostic imaging system for evaluating real-time print quality using backscattered light from an off-axis source;

FIG. 2E illustrates a block diagram of an example additive manufacturing system suitable for handling and measuring characteristics of new or recycled powder;

FIG. 3 illustrates an additive manufacturing system able to direct one or two dimensional light beams for measuring characteristics of new or recycled powder and fusing powder to form structures;

FIG. 4 illustrates a method for operation of an additive manufacturing system able to direct one or two dimensional light beams for measuring characteristics of new or recycled powder and fusing powder to form structures; and

FIG. 5 illustrates an additive manufacturing system able to direct one or two dimensional light beams using a switchyard systems and allowing for measuring characteristics of new or recycled powder and fusing powder to form structures.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

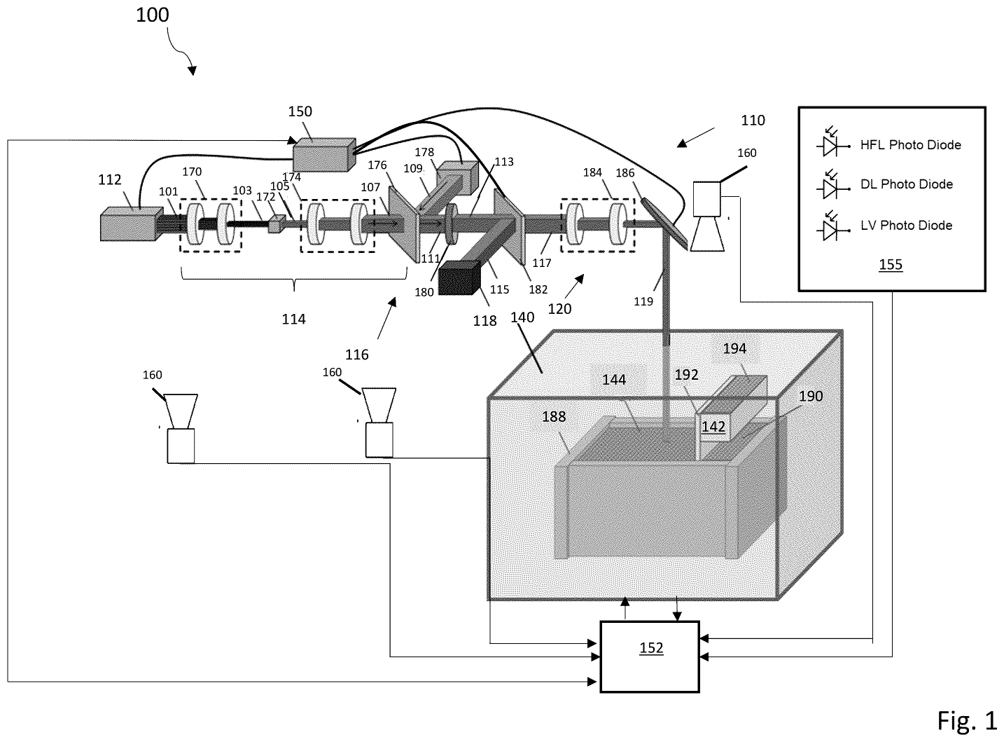

FIG. 1 illustrates one embodiment of an additive manufacturing system 100 that uses multiple semiconductor lasers as part of an energy patterning system 110. A control processor 150 or 152 can be connected to variety of sensors, actuators, heating or cooling systems, monitors, and controllers to coordinate operation of multiple lasers 112, light patterning unit 116, and image relay 120, as well as any other component of system 100. As will be appreciated, connections can be wired or wireless, continuous or intermittent, and include capability for feedback (for example, thermal heating can be adjusted in response to sensed temperature). The multiple lasers 112 can emit a beam 101 of light. In one embodiment, a beam at 1000 nm wavelength can be used. In an example the beam can be 90 mm wide by 20 mm tall. The beam 101 can be resized by imaging optics 170 to create beam 103. In an example, beam 103 can be 6 mm wide by 6 mm tall and is incident on light homogenization device 172 which blends light together to create blended beam 105. Beam 105 can then be incident on imaging assembly 174 which reshapes the light into beam 107. Beam 105 is then incident on hot cold mirror 176. The mirror 176 allows light of a first wavelength to pass but reflects light of a second wavelength. For example, 1000 nm light can pass, but 450 nm light can be reflected. Light projector 178 is capable of projecting low power light. For example, light projector 178 may project light at 1080p pixel resolution and 450 nm. Light projector 178 can emit beam 109, which is then incident on hot cold mirror 176. Beams 107 and 109 overlay in beam 111, and both are imaged onto optically addressed light valve 180. Images formed from the homogenizer 172 and the projector 178 are recreated and overlaid on light valve 180.

The optically addressed light valve 180 is stimulated by the light (for example, light ranging from 400-500 nm) and imprints a polarization rotation pattern in transmitted beam 111 which is incident upon polarizer 182. The polarizer 182 splits the two polarization states, transmitting p-polarization into beam 117 and reflecting s-polarization into beam 115 which is then sent to a beam dump 118 that handles the rejected energy. As will be understood, in other embodiments the polarization could be reversed, with s-polarization formed into beam 117 and reflecting p-polarization into beam 115. Beam 117 enters the final imaging assembly 120 which includes optics 184 that resize the patterned light. This beam reflects off of a movable mirror 186 to beam 119, which terminates in a focused image applied to material bed 144 in an article processing unit 140. The depth of field in the image selected to span multiple layers, providing optimum focus in the range of a few layers of error or offset.

The article processing unit 140 can be connected to a one or both of control processors 150 and 152. Control processors 150 and 152 can be connected to variety of sensors, actuators, heating or cooling systems, monitors, and controllers to coordinate operation of the bed 190 and other article processing unit 140 components. These can include cameras 160 and photodiodes 155 to monitor the energy patterning system 110 (including e.g. high fluence laser (HFL), diode lasers (DL), or light valves (LV)), as well as monitoring bed and powder conditions in the article processing unit 140. As will be understood, processors 150 and 152 can be connected to each other or to other control units not illustrated and can be operated independently or in conjunction with each other.

In one embodiment, the bed 190 can be raised or lowered (vertically indexed) within chamber walls 188 that contain material 144 dispensed by material dispenser 142. Materials 144 that are applicable for these techniques can include metal, ceramic, glass, and polymer. For example, any metal obtainable in powder form (including but not limited to steels, copper, aluminum, titanium, tungsten, various alloys, etc.) In various examples, metal powder size and can be in the sub-micron to sub-millimeter range. In other examples ceramic or glass in powder form can be used. The ceramic or glass powder can be composed of materials that have a close glass transition temperature. Powder size for glass or ceramic powders can be in the sub-micron to sub-millimeter range. In the plastic category, any of the semi-crystalline polymers (including but not limited to polyamides, polystyrenes, polypropylenes, thermoplastic elastomers, and polyaryletherketones), plastic powder size can be in the sub-micron to sub-millimeter range.

In certain embodiments, the bed 190 can remain fixed, and optics of the final imaging assembly 120 can be vertically raised or lowered. Material distribution is provided by a sweeper mechanism 192 that can evenly spread material powder held in hopper 194, being able to provide new layers of material as needed. An image can be sequentially directed by the movable mirror 186 at different positions of the bed.

When using a powdered ceramic or metal material in this additive manufacturing system 100, the powder can be spread in a thin layer, approximately 1-1 particles thick, on top of a base substrate (and subsequent layers) as the part is built. When the powder is melted, sintered, or fused by a patterned beam 119, it bonds to the underlying layer, creating a solid structure. The patterned beam 119 can be operated in a pulsed fashion. For example at 40 Hz. The subsequent 6 image locations can be moved, for example at intervals of 10 ms to 0.5 ms (with 3 to 0.1 ms being desirable) until the selected patterned areas of powder have been melted. The bed 190 then lowers itself by a thickness corresponding to one layer, and the sweeper mechanism 192 spreads a new layer of powdered material. This process is repeated until the 2D layers have built up the desired 3D structure. In certain embodiments, the article processing unit 140 can have a controlled atmosphere. This allows reactive materials to be manufactured in an inert gas, or vacuum environment without the risk of oxidation or chemical reaction, or fire or explosion (if reactive metals are used).

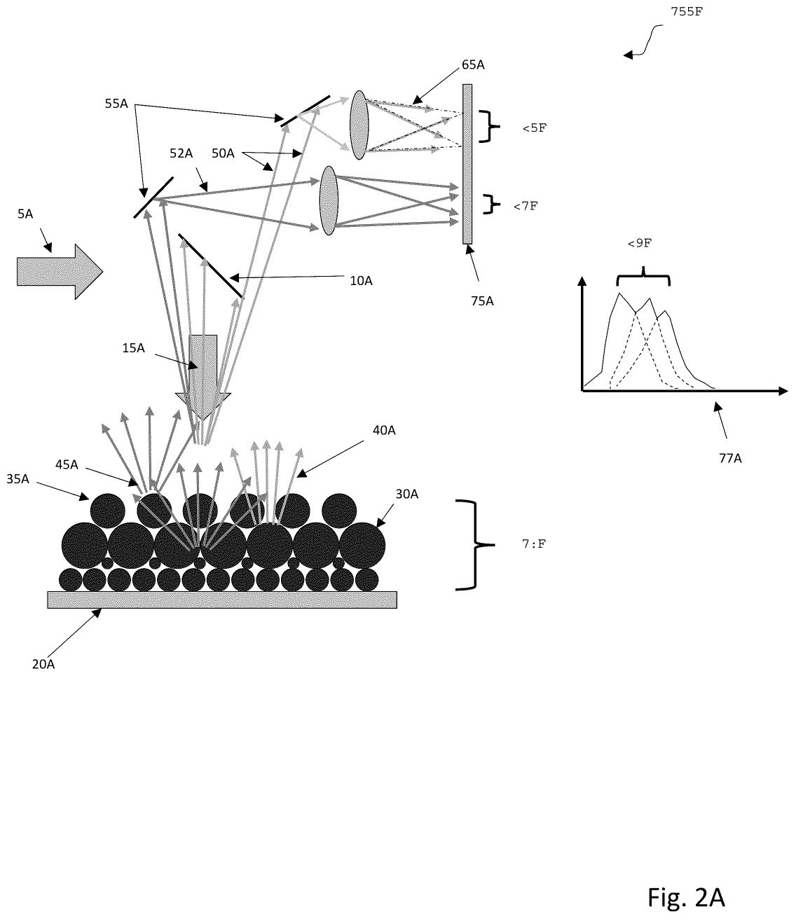

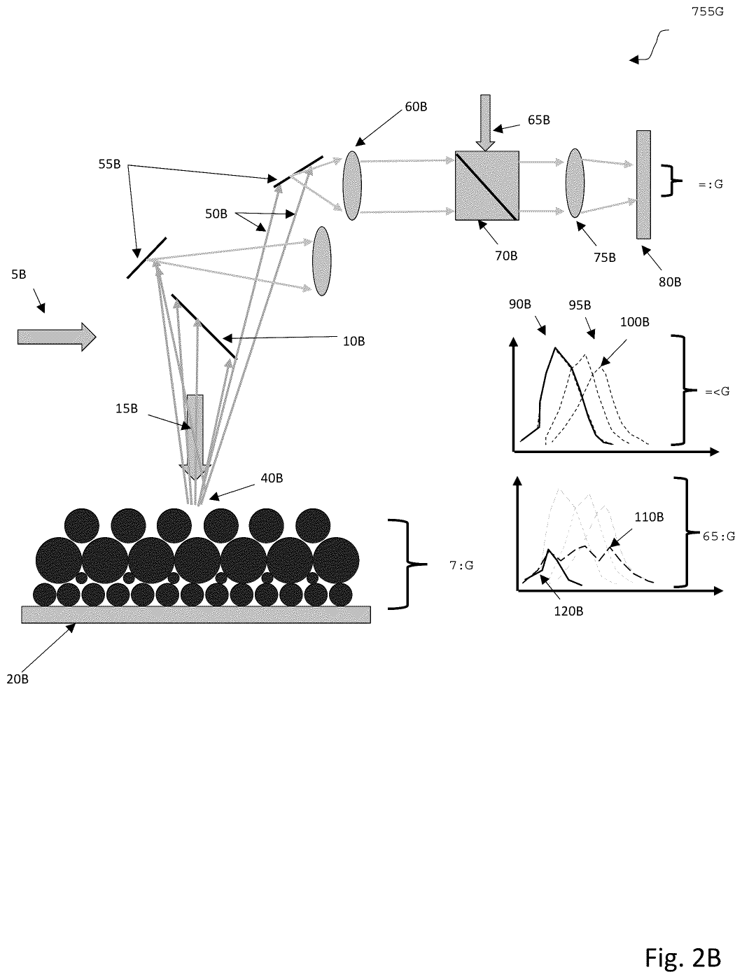

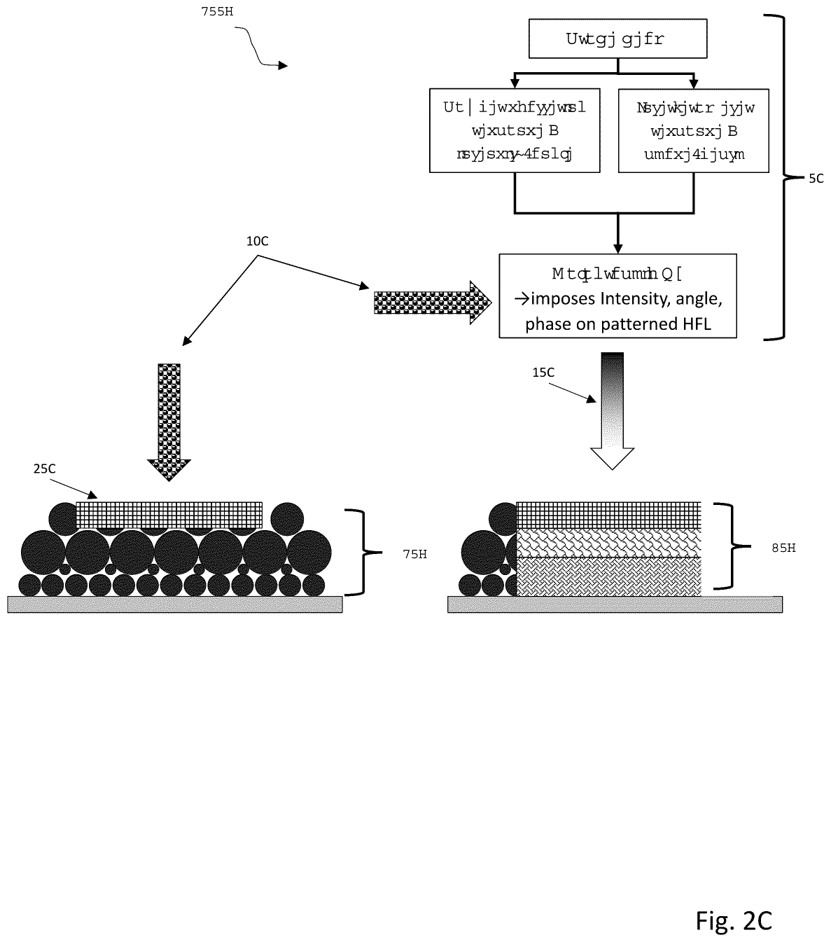

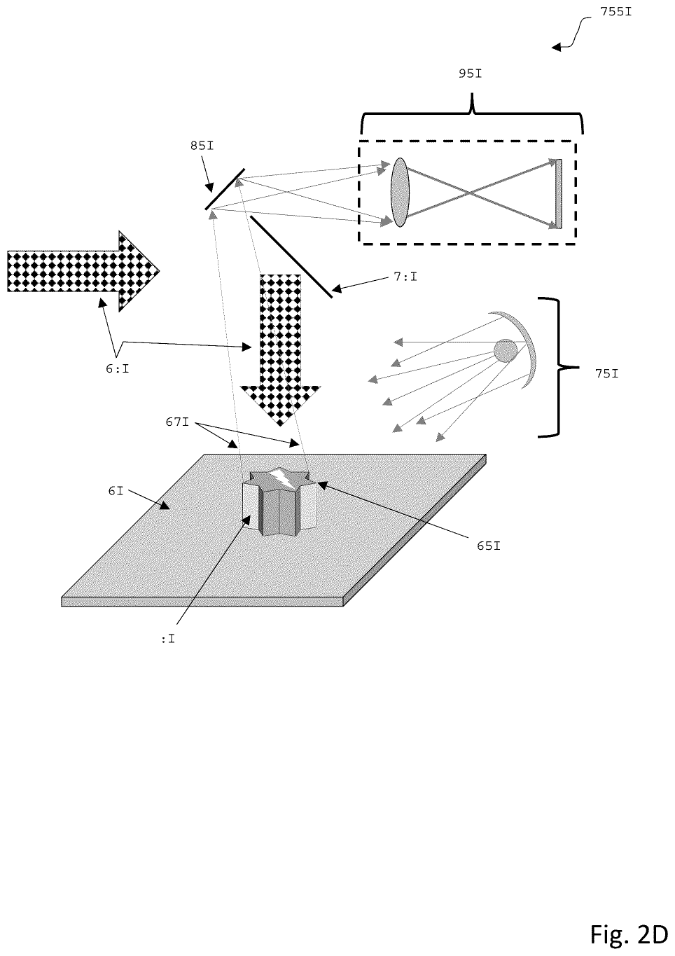

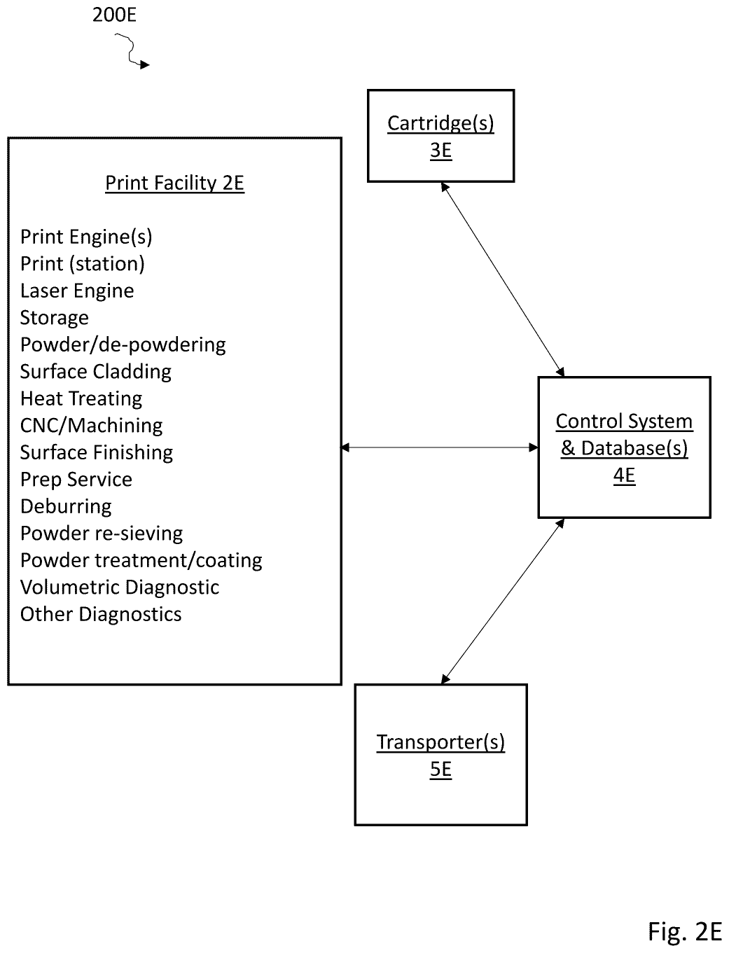

FIG. 2A illustrates one embodiment of a diagnostic and measurement technique (suitable for use in connection with a system such as described with respect to FIG. 1) that relies on backscatter measurement for powder size determination on a print bed. In some embodiments, incident scattering off small particles that are larger than the wavelength of light will generate an angular set of rays that are dependent on that size particle(i.e. smaller particles will scatter light into wider angles than larger particles). Additionally, since all the particles receive equal amount of laser fluence, integrated energy per solid angle scattered favors larger particles than the smaller particles, so that power versus subtended reception will fall into distinct spatial imaging bins if the optical system is set up to produce optical Fourier transforms onto detections planes. As seen with respect to optical measurement system 200A, an incoming probe beam 5A enters into a galvo system 10A of an additive manufacturing printer, reflecting off the galvo system 10A, and striking powder 25A resting on build plate 20A. Typically, the fluence in the incident beam 15A is uniform and strikes the powder equally across its extent. If the powder is composed of a distributions of powder particles (e.g. large to small spheres 30A and 35A), respectively which when struck by beam 15A will scatter into a set of discrete range reflections 40A associated with 30A size and 45A with 35A size. This distribution of scattered light from 15A interacting with 25A produces a set of rays that span those that hit 10A and those that are in larger angles. These high angle light passes 50A on the outskirt of 10A and are picked up by one or more stray light reflectors 55A that redirect 55A into 60A. If a lens 60A is placed one focal length away from a detection plane 75A an optical Fourier transform of 55A on 75A is produced. An optical Fourier transform (OFT) transforms angled light into spatial locations about 60A's center of rotation axis on 75A and forms a distribution 70A that correlates to the size of particle that generated it. The higher the angle (correlating to smaller particles) will produce a larger distribution on 75A. The small diameter spheres response to 15A is exemplified by the detected spread on 75A of 72A while the large spheres response is exemplified by 72A on 75A. An example OFT response curve of three diameter sphere distributions is shown in 77A with each distribution shown as dotted lines beneath a combined curve 74A.

In an alternative embodiment, a main HFL beam or the DL beam is used to illuminate 25A with the detection of the OFT still as shown. Another embodiment can transfer the backscatter field out of the chamber. Advantageously, this would reduce cost and complexity associated with moving optical measurement system 200A in tandem with optics of galvo system 10A.

FIG. 2B illustrates an example of use of backscatter and controlled coherency system 200B to determine powder size and powder depth. In one example, coherency of the probe beam 5B is controlled by an electro-optic phase delay in its gain cavity or prior to coming into system 200B. In some embodiments coherence of a probe beam 5B can be adjusted such that when the backscattered light is interfered (optically mixed) at a detection plane, certain sizes are registered while smaller sized particles are not detected. This allows a depth profile to be determined based on coherency (depth) and scatter profiles (sphere diameter).

In an example, probe bean 5B enters a galvo system and reflects off 10B so that 5B becomes 15B before interacting with a variety of different diameter powder (25B) on the build plate (20B). The backscatter response (40B) from 15B interacting with 25B produces a set of angled light composed of in part of high angle light 50B that is not retro reflected by 10B but is collected by 55B before being collimated by lens 60B. This collect light is injected into a beam splitter, 70B, which merges it with a delayed sample of 5B that is now 65B (acting as a reference beam). The combined reference and sample scattered beam passes through an OFT lens (74B) where they are focused on a detection plane (80B) for their interference pattern (85B) is detected and recorded. For a particular optical delay imposed onto 65B by its phase LV, an exemplary scattering interference pattern may look this 87B in the case for three sphere distributions with a distinct patterned response (90B) for the sphere size that coincides with coherence function that are shared by 5B and 65B. By adjusting the coherence of 5B and 65B one can sweep a range of sphere sizes at a particular plane parallel to 20B and within 25B. This ability to dial in a sphere size is unique to optical coherence sources with its readout as described using an interferogram. As the coherence of 5B/65B is changed, other curves are made evident, such as 95B and 100B. Assuming that 90B is attributed to large spheres and this becomes evident at one extreme of the coherency function while 100B is associated with the small spheres, then as one changes the coherency function of 5B/65B to the other extreme, the curve shown in 90B wanes while initially 95B becomes evident and then recedes and then 100B becomes evident toward the other extreme of the coherency function.

By adjusting the phase delay between 5B and 65B with the phase LV (not shown), one can scan in depth depicted in 105B. The prior peaks depicted in 87B are depicted in 105B as faded curves would not be evident scan with their peak locations being stable (the peaks would relate to sphere sizes). The reduction of distribution intensity (Y-axis on these curves) is indicative of depth and the amount of scattering loss that depth into 25B imposes on 40B. Thus, adjusting coherence of 5B/65B provides sphere sizes (from 87B curve) while adjusting phase on 65B provides depth measurements. As in 87B, in 105B, adjusting the coherency function of 5B/65B, one can ‘dial-in’ a sphere size with 120B associated with 90B and 110B with 100B distributions within 25B.

While the phase delay on 65B need not be pixelated (the LV in this case could be replaced by an area non-pixelated electro-optical phase cell—it does need to be programmable to allow on-demand depth analysis), having a pixelated adjustability allows for depth compensation on the measurement due to fine scatters and non-uniformity in the distributions to be measured at any one depth. Additionally, the area measurement of 5B/65B with a pixelated phase LV delay on 65B allows for the user to examine any portion of the voxel volume afforded by the coherency function of 5B/65B (a single plane) with the phase delay on each pixel overlap between 5B and 65B (the third/depth dimension in the interferogram produced with these two image planes interfere on 80B.

Other embodiments of this system can replace the phase LV on 65B with a set of static phase plates, reducing cost at the expense of voxel space resolution. Other embodiments would be to replace the probe beam with either the HFL or diode beam. Such embodiment can reduce system complexity but may require a fast imager at 80B, depending on how timing works for interfering with short pulse sources.

Yet another embodiment is to use HFL/diode as 5B/65B but use the rejected light from the patterning LV and run this rejected light through a switchyard system for reformatting and pattern conditioning, thus 5B would be the patterning HFL/diode and 65B would be the reformatted rejected light.

Yet another embodiment is to use this technique on either the bare build plate before a print or on the top layer of a current print to determine remelt requirements in either case.

Yet another embodiment is to use other interferometer configurations; in 1000B collinear combining is performed using the beam splitter, 70B. Instead, a Mach-Zender arrangement can be used if 5B and 65B are polarized. Additionally, if polarization is used, then this modality could be used to gain insight into stress or currently printed parts.

FIG. 2C illustrates an example of volumetric printing system 200C in additive manufacturing using adaptive optical techniques with backscatter coherence analysis. This technique uses an adaptive optics adaption utilizing vector processing of the HFL/diode beams and in conjunction with a holographic LV. The flow logic of the backscatter coherence analysis is depicted in 5C with the probe beam interacting with the powder bed before a print occurs and phase information on the probe beam is used with the coherency function to determine the complex scattering parameters from the powder layer (20C). This complex scattering response would normally scramble the patterned HFL/diode beams (10C) and which would only allow the top surface of the powder layers (20C) to be printed with the HFL pattern (25C). In this system the response of the probe beam as rendered by 5C would be inputs to a holographic LV that would impose vector modifications (intensity, angle, and phase) to the HFL/diode beams so that when they interacted with 20C in the form of 15C would form a voxel image within the powder and allowing for a voxel print to occur (30C).

FIG. 2D illustrates an example of a diagnostic imaging system 200D for evaluating real-time print quality using backscattered light. In this system 200D, a print (5D) is in process on a build plate, ID, with the current print plane (10D) being inspect by the various imaging diagnostics (40D). The patterned HFL/diode (15D) enters into the build chamber and reflects off the galvo mirror (25D) to form 10D. An off-axis illumination system (20D) illuminates 10D producing backscatter light, some of which is beyond the angular extent of 25D but is captured by the backscatter optical system composed of turning mirror (30D) and a diagnostic imaging system 40D. The side illumination can be in multiple positions around the 10D with more luminaires resulting in fewer shadows in the final image. The illumination and diagnostics can be in wavelengths and polarizations that are not used by 15D to enhance the diagnostic contrast function due to lower detected optical noise. The illumination be pulsed or synchronized to be outside of the temporal firing of the HFL/diodes to enhance the diagnostic electrical contrast function and aid in eliminating electrical noise while enhancing the received optical space-time bandwidth from 20D.

Other embodiments can use HFL/diode beams as the illumination for the part with the collection being as shown in addition to light passing through 25D into a secondary diagnostics to measure the melt pool characteristics and dynamic aspects as this pool cools/condenses and solidifies.

FIG. 2E illustrates an additive manufacturing system 200E that can support various control and diagnostic monitoring such as discussed with respect to FIG. 1 and FIGS. 2A-D. System 200E includes a variety of potential stations in a print facility 2E. In some embodiments a powder bed is provided by a removable cartridge that can loaded into a station. In certain embodiments, a plurality of article processing units, cartridges, or build chambers, each having a build platform to hold a powder bed, can be used in conjunction with multiple optical-mechanical assemblies arranged to receive and direct the one or more incident energy beams into the cartridges. Multiple cartridges allow for concurrent printing of one or more print jobs. An example of a station can be the cartridge-equipped print station in which energy (laser or electron beam) is delivered into it from a laser engine (station) to enable it to print a part. Typically, a laser engine is only used in conjunction with a print station to turn the combination into a print engine. The stations can be arranged and connected to each other to form a manufacturing system. A manufacturing system may contain many cartridge-equipped stations, and support stations captured in a frame arrangement, coordinated by a control system and which takes print instructions from the user in order to fulfil print orders/jobs. These other functional stations can contain dirty processes to reduce human exposure in making a 3D part. Additionally, a system interface can be provided for interaction with various diagnostics systems. The control system and database(s) 4E can communicate with a cartridge or other print bed or article processing system, separately or when it is connected to any one of the listed station(s) (2E) or while it is being manipulated by a transporter 5E. The station(s) listed is not an all-inclusive list but do include the print engine (composed of a print station and a laser engine), a storage (rack) station, a facility station, and a powder prep/de-powdering station. The powder prep station could be one station for prepping a powder bed which can include removing powder that already had undergone printing. These two functions (prepping a powder bed and powder removal) could be done in one station or two separate in which case the prepping station could be called ‘prep’ while the other could be called ‘de-powdering’. The other stations can include surface cladding station, heat treating station, CNC/machining station, surface finishing station, a prep service station, a de-burring station, a powder re-sieving station, a powder surface treatment/coating station, the diagnostic station, other volumetric and surface diagnostic station, and other processing station. The laser engine mates to and interacts with the print station (to form a print engine), the surface cladding station, the diagnostic station, and may interact with heat treating station and the surface finishing station.

The print station, the surface cladding station, the heat-treating station, the CNC/machining station, the surface finishing station, and the deburring station can be used for post processing on the printed part. The surface cladding station in conjunction with the laser engine operates on the printed part to add a functional layer to selected surfaces as in the case of drill bits, airfoil surfaces, turbine blades or medical implants. The heat-treating station, in conjunction with the laser engine can perform surface annealing and hardening or it can do this form of post processing using other traditional methods such as standard thermal sources or directed energy non-laser sources. The CNC/machining station performs standard subtractive manufacturing on a printed part for final figure and form. The surface finishing station can interact with the laser engine to perform surface smoothing via mass transport/surface tension, or laser peening/hardening. The surface finishing station can also be performed in more traditional subtractive methods as well. The deburring station can use traditional subtractive machining methods to enhance surface finish of the printed part.

The prep service station is used to service system 200E and may be used in conjunction with the powder station and facility station. In the prep station, consumables are replaced in a manner to minimize human interaction with the dirty environments. Gases and fluids are removed for post processing via the facility station. Used powder is removed and transferred to the powder re-sieving station for powder recovery.

The powder treatment/coating station treats the powder for chemistry or emissivity enhancements, this can depend on which powder/metal is being used but could include chemical or oxide treatment to enhance emissivity (such as increasing the absorption of copper or steel by surface treatment of the powder) of by adding chemical dopants to the powder for special print parameters.

A diagnostic station can couple with a laser engine to volumetric scan the printed part to ensure print accuracy, density, and defect statistics. Additionally, volumetric or other diagnostics, including those discussed with respect to FIG. 1 and FIGS. 2A-D, can be used in conjunctions with a storage station and the laser engine to determine functionality of the printed part under conditional environments such as high or low heat, high pressure or partial vacuum, or other environmental or operation extremes to ensure the printed part can withstand static operational performance requirements.

Other diagnostics stations can include x-ray tomography, surface scanning imaging, high resolution surface and thermography imaging to name a few in which the printed part is manipulated while minimizing handling damage and not exposing the human to dangerous metrology methods (as in the x-ray tomography case).

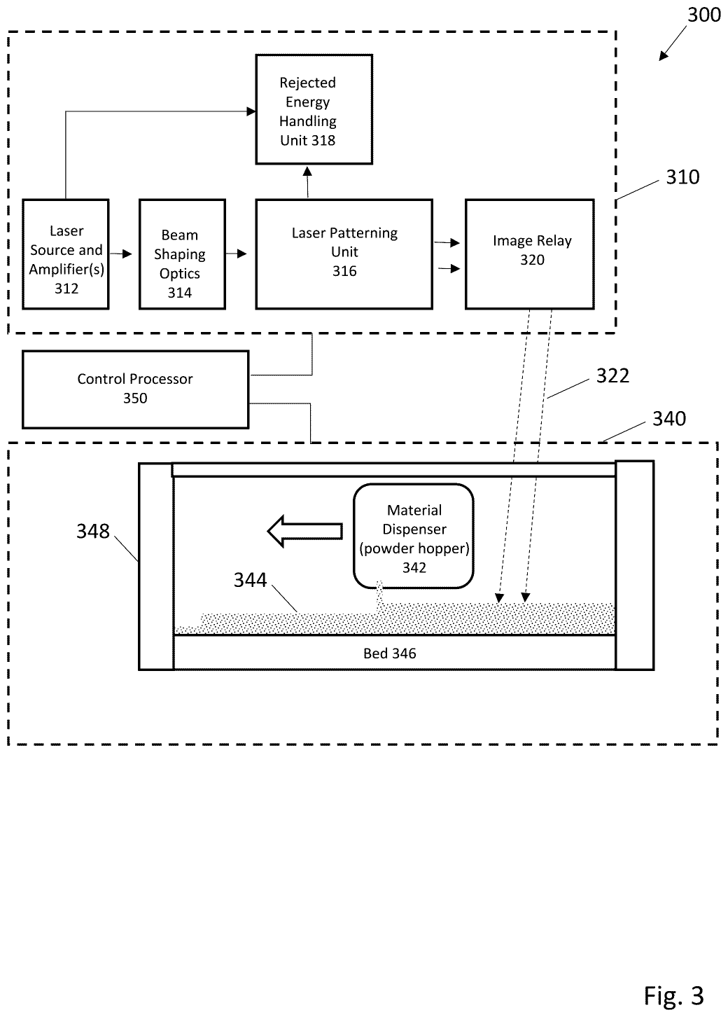

In another embodiment illustrated with respect to FIG. 3, additive manufacturing systems can be represented by various modules that form additive manufacturing method and system 300. As seen in FIG. 3, a laser source and amplifier(s) 312 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulsed source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NcCu) metal-vapor laser, Copper vapor laser, Gold vapor laser, or Manganese (Mn/MnCl2) vapor laser. Rubidium or other alkali metal vapor lasers can also be used. A Solid State Laser can include lasers such as a Ruby laser, Nd: YAG laser, NdCrYAG laser, Er: YAG laser, Neodymium YLF (Nd:YLF) solid-state laser, Neodymium doped Yttrium orthovanadate(Nd: YVO4) laser, Neodymium doped yttrium calcium oxoborateNd: YCa40(BO3)3 or simply Nd: YCOB, Neodymium glass(Nd:Glass) laser, Titanium sapphire(Ti:sapphire) laser, Thulium YAG (Tm:YAG) laser, Ytterbium YAG (Yb: YAG) laser, Ytterbium:203 (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride(Ce:LiSAF, Ce:LiCAF), Promethium 147 doped phosphate glass(147Pm+3:Glass) solid-state laser, Chromium doped chrysoberyl (alexandrite) laser, Erbium doped and erbium-ytterbium co-doped glass lasers, Trivalent uranium doped calcium fluoride (U:CaF2) solid-state laser, Divalent samarium doped calcium fluoride(Sm:CaF2) laser, or F-Center laser.

A Semiconductor Laser can include laser medium types such as GaN, InGaN, AlGaInP, AlGaAs, InGaAsP, GalnP, InGaAs, InGaAsO, GalnAsSb, lead salt, Vertical cavity surface emitting laser (VCSEL), Quantum cascade laser, Hybrid silicon laser, or combinations thereof.

As illustrated in FIG. 3, the additive manufacturing system 300 uses lasers able to provide one- or two-dimensional directed energy as part of an energy patterning system 310. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 310 uses laser source and amplifier(s) 312 to direct one or more continuous or intermittent energy beam(s) toward beam shaping optics 314. After shaping, if necessary, the beam is patterned by an energy patterning unit 316, with generally some energy being directed to a rejected energy handling unit 318. Patterned energy is relayed by image relay 320 toward an article processing unit 340, in one embodiment as a two-dimensional image 322 focused near a bed 346. The article processing unit 340 can include a cartridge such as previously discussed. The article processing unit 340 has plate or bed 346 (with walls 348) that together form a sealed cartridge chamber containing material 344 (e.g. a metal powder) dispensed by powder hopper or other material dispenser 342. Dispensed powder can be created or recycled as discussed in this disclosure. Patterned energy, directed by the image relay 320, can melt, fuse, sinter, amalgamate, change crystal structure, influence stress patterns, or otherwise chemically or physically modify the dispensed and distributed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 316 can include static or dynamic energy patterning elements. For example, laser beams can be blocked by masks with fixed or movable elements. To increase flexibility and case of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

The material dispenser 342 (e.g. powder hopper) in article processing unit 340 (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO2, N2, 02, SF6, CH4, CO, N20, C2H2, C2H4, C2H6, C3H6, C3H8, i-C4H10, C4H10, 1-C4H8, cic-2,C4H7, 1,3-C4H6, 1,2-C4H6, C5H12, n-C5H12, i-C5H12, n-C6H14, C2H3C1, C7H16, C8H18, C10H22, C11H24, C12H26, C13H28, C14H30, C15H32, C16H34, C6H6, C6H5-CH3, C8H10, C2H5OH, CH3OH, iC4H8. In some embodiments, refrigerants or large inert molecules (including but not limited to sulfur hexafluoride) can be used. An enclosure atmospheric composition to have at least about 1% He by volume (or number density), along with selected percentages of inert/non-reactive gasses can be used.

Control processor 350 can be connected to control any components of additive manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

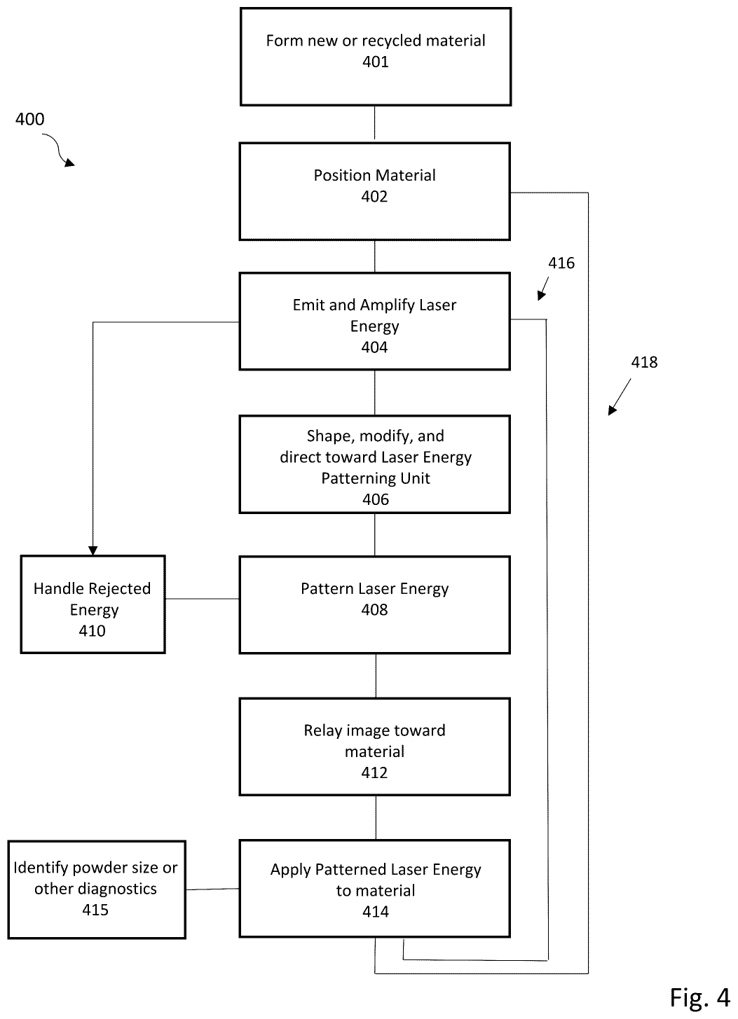

One embodiment of operation of a manufacturing system suitable for additive or subtractive manufacture is illustrated in FIG. 4. In this embodiment, a flow chart 400 illustrates one embodiment of a manufacturing process supported by the described optical and mechanical components and that includes use of various optical diagnostic systems such as previously described herein. In step 401, material powder created or recycled as discussed in this disclosure is formed. In step 402, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. Information derived from applying patterned laser energy to a material can be used to identify powder size or other need diagnostics or measurements (step 415). For additive manufacturing, these steps can be repeated (loop 418) until the image (or different and subsequent image) has been applied to all necessary regions of a top layer of the material. When application of energy to the top layer of the material is finished, a new layer can be applied (loop 416) to continue building the 3D structure. These process loops are continued until the 3D structure is complete, when remaining excess material can be removed or recycled.

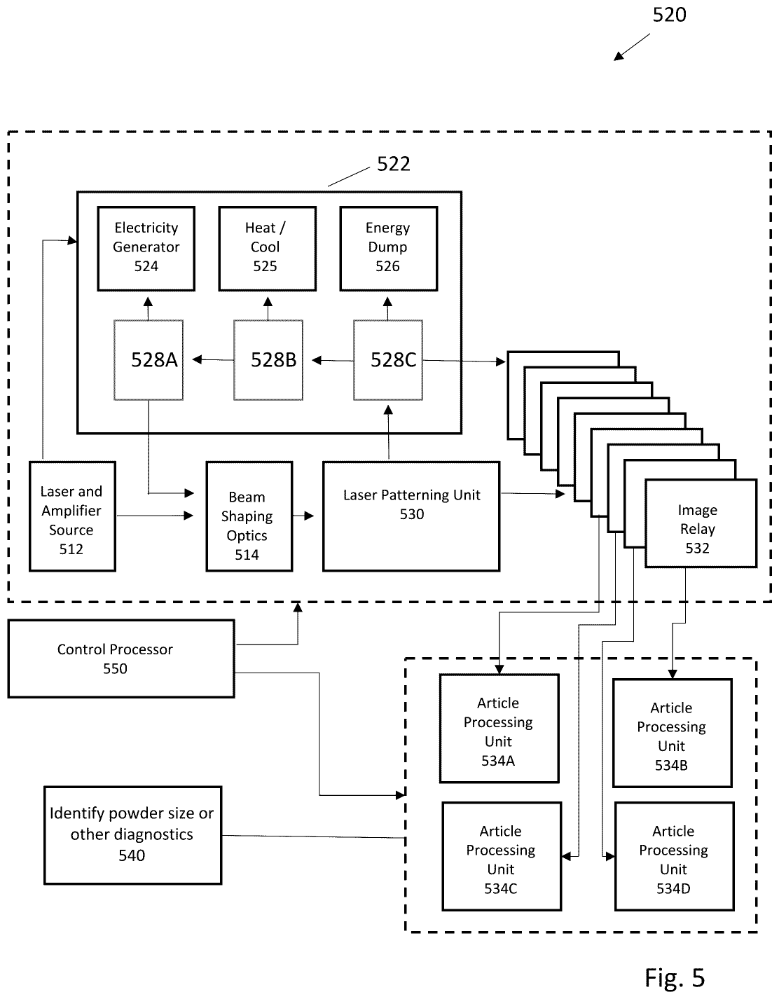

FIG. 5 is one embodiment of an additive manufacturing system that includes a phase change light valve and a switchyard system enabling reuse of patterned two-dimensional energy. An additive manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units 534A-D. Advantageously, reuse of the patterned light can improve energy efficiency of the additive manufacturing process, and in some cases improve energy intensity directed at a bed or reduce manufacture time. In some embodiments, information derived from applying patterned laser energy to material in one or more of the article processing units 534A-D can be used to identify powder size or other needed diagnostics or measurements using diagnostic module 540 and techniques and systems previously discussed with respect to FIG. 1 and FIGS. 2A-D.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A print engine of an additive manufacturing system that supports powder measurement systems, comprising:
a print bed able to hold powder of varying sizes:
a laser energy patterning system directable against the print bed; and
a backscatter detection system able to evaluate scattered light distribution from powder on the print bed and determine powder size.

2. The print engine of claim 1, wherein the laser energy patterning system is able to direct a two dimensional laser image against the print bed.

3. The print engine of claim 1, wherein the laser energy patterning system comprises a high fluence laser.

4. The print engine of claim 1, wherein the laser energy patterning system comprises a diode laser.

5. The print engine of claim 1, wherein the backscatter detection system uses an optical Fourier transform.

6. A print engine of an additive manufacturing system that supports powder measurement systems, comprising:
a print bed able to hold powder of varying sizes;
a laser energy patterning system directable against the print bed; and
a detection system able to determine powder size and powder depth using a coherent probe and a backscattered response that are combined to provide an interference pattern.

7. The print engine of claim 6, wherein the laser energy patterning system is able to direct a two dimensional laser image against the print bed.

8. The print engine of claim 6, wherein the backscatter detection system uses static phase plates.

9. The print engine of claim 6, wherein the backscatter detection system uses rejected light from a light valve in the laser energy patterning system.

10. The print engine of claim 6, wherein the backscatter detection system uses a Mach-Zender interferometer.

11. A print engine of an additive manufacturing system that supports powder measurement systems, comprising:
a print bed able to hold powder of varying sizes;
a laser energy patterning system having a holographic light valve that can pattern laser energy directable against the print bed; and
a detection system able to determine powder size and powder depth using a coherent probe and a backscattered response; wherein the detection system response is used to modify inputs to the holographic light valve that enable volumetric voxel printing using the laser energy patterning system.

12. The print engine of claim 11, wherein the laser energy patterning system is able to direct a two dimensional laser image against the print bed.

13. A print engine of an additive manufacturing system that supports powder measurement systems, comprising
a print bed able to hold powder of varying sizes,
a laser energy patterning system having a high fluence laser directable against the print bed,
a detection system able to determine powder size and powder depth using off axis backscattered illumination timed to illuminate the print bed and any contained articles when the high fluence laser is not firing.

14. The print engine of claim 13, wherein the laser energy patterning system is able to direct a two dimensional laser image against the print bed.

15. A laser energy patterning system, comprising
multiple semiconductor lasers directed toward a light homogenization device that forms a blended beam directed at a hot cold mirror that allows light of a first wavelength to pass but reflects light of a second wavelength;
a light projector that projects light of the second wavelength at the hot cold mirror, allowing the blended beam to overlay with projector light reflected from the hot cold mirror; and
a light valve stimulated by incident second wavelength light to form an image pattern on the light valve that transmits a first portion of the blended beam and reflects a second portion of the blended beam into a beam dump.

16. The laser energy patterning system of claim 15, wherein the transmitted first portion of the blended beam passing through the light valve is directed against a print bed able to hold powder of varying sizes.

17. The laser energy patterning system of claim 16, further comprising a detection system able to determine powder size and powder depth in the print bed using a coherent probe and a backscattered response that are combined to provide an interference pattern.
